(19) United States
(12) Patent Application Publication
(10) Pub. No.: US 2007/0012113 A1
(43) Pub. Date: Jan. 18, 2007

(54) Non-contact detection

(75) Inventor: Kevin Ulmer, Cohasset, MA (US)

Correspondence Address: EDWARDS & ANGELL, LLP, P.O. BOX 55874, BOSTON, MA, 02205, US

(73) Assignee: Helicos BioSciences Corporation, Cambridge, MA (US)

(21) Appl. No.: 11/184,360

(22) Filed: Jul. 18, 2005

(51) Int. Cl. G01N 29/04

(52) U.S. Cl. 73/618; 73/290 V

(57) ABSTRACT

Sensors, including ultrasonic components, within a robotic system facilitate the overall operation and efficiency of the robotic system through the detection of objects and surfaces, including the levels of liquids, without contacting the objects or surfaces. The sensors are well-suited for use in connection with microfluidic volumes and biological materials.

### TECHNICAL FIELD

The present invention relates generally to detection systems and methods such as those used in connection with a robotic system to provide detection of objects and surfaces such as liquid levels, without contacting the objects or surfaces.

### BACKGROUND INFORMATION

Robotic systems for the manipulation of objects typically require varying degrees of human control. For example, a human operator, using a hardware or software interface to a controller of a robotic system, directs the position of manipulators or other movable elements to perform particular tasks. This requires that the operator be vigilant for changing or unexpected conditions, so as to react accordingly and alter the operation of the system, if necessary.

As tasks become more complex, it becomes increasingly difficult for an operator to control the robotics under changing conditions. Consequently, sophisticated robotic systems typically employ sensors that provide data to the system controller, and software that interprets the data and performs automatic adjustments to system operation. This generally occurs with little or no operator intervention.

Robotic systems designed to handle fluid volumes, chemicals, and biological materials typically manipulate fluid-handling apparatus, such as vials, pipettes, tubes, plates, lids, and the like in order to dispense, collect, and monitor samples. One example of such a robotic system is the Microlab® STARlet, which is commercially available from the Hamilton Company of Reno, Nev. That robotic system provides automated liquid handling, typically involving biological materials, using pipettes and other manipulating hardware.

There is a need in the art for improved robotic systems for the handling of liquids.

### SUMMARY OF THE INVENTION

The present invention provides systems and methods comprising independently-movable controllers for monitoring and manipulating objects. In a particular embodiment, the invention provides non-contact sensors that monitor the status and characteristics of surfaces, including liquid surface levels. Methods of the invention allow for the control of characteristics of the surfaces being monitored. For example, sensors according to the invention monitor the level of a liquid in a reservoir, and further communicate information to controllers that interact to control liquid levels and contents in the reservoir. In a preferred embodiment, sensors and controllers of the invention gather data and control downstream manipulation without physically contacting the sample. Robotic systems that incorporate sensors of the invention are able to modify their operation as conditions change.

In one aspect, the invention features a system comprising two or more independently controllable and movable devices, at least one of which comprises an ultrasonic transmitting and receiving module. The module is used to measure parameters, such as the location of objects, the level of liquids, and surface properties. One or more of the devices can be used to manipulate objects, dispense liquids and perform other functions at the direction of a programmer.

In certain embodiments, a robotic system uses movable devices to collect and/or dispense a sample volume, and then to monitor the level of the dispensed liquid. In one example, monitoring is accomplished using an ultrasonic sensor that is attached to a movable device so that it can be placed over a dispensed fluid volume. As the dispensed liquid is transferred (i.e., for transport to other hardware for analysis), the sensor monitors fluid level and discontinues transferring the liquid at a predetermined level. In one embodiment, the sensor monitors fluid level to cause a predetermined fill level and/or a dispensing level. In particular, as discussed below, the sensor determines when a fluid reservoir is empty and communicates with control apparatus to terminate fluid dispensing.

In a preferred embodiment of the invention, ultrasonic sensors are used to monitor and detect a liquid level in a reservoir. In such an embodiment, fluid is dispensed into the reservoir and an ultrasonic probe monitors the dispensed liquid level. The ultrasonic probe may be attached to the dispensing robotics or may be separate. At a predetermined fill level, the sensor terminates the dispensing operation. The same or a different sensor is used to monitor liquid level in the reservoir as liquid is transferred from the reservoir. In one embodiment, the reservoir is a funnel into which reagents are placed for use in chemical and biochemical reactions. In a preferred embodiment, the reservoir comprises beveled edges in order to deflect ultrasonic waves from a detector so as to prevent false level reading.

Another aspect of the invention comprises using alternative non-contact sensing technologies, such as radar, LIDAR, and vision systems, to provide data to a robotic system.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1A is a perspective view depicting a robotic system in accordance with an embodiment of the invention;

FIGS. 1B, 1C, and 1D are perspective views depicting a portion of the robotic system in FIG. 1A in accordance with an embodiment of the invention;

FIG. 2A is a schematic sectional view depicting a funnel that can be used in connection with the operation of the system of FIG. 1A;

FIG. 2B is a schematic plan view depicting a funnel that can be used in connection with the operation of the system of FIG. 1A; and

FIG. 3 is a flow chart depicting a method for real-time detection of liquid level in accordance with an embodiment of the invention.

### DESCRIPTION

As shown in the drawings for the purposes of illustration, the invention may be embodied in systems and methods for detecting surfaces dynamically without contacting those surfaces. Embodiments of the invention are useful in conjunction with robotic systems.

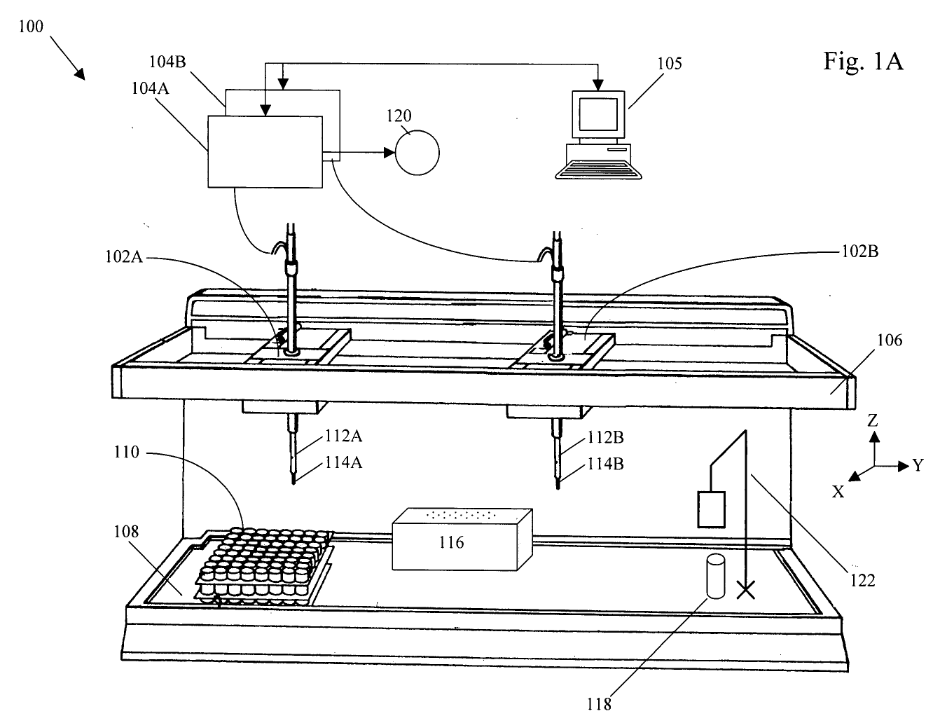

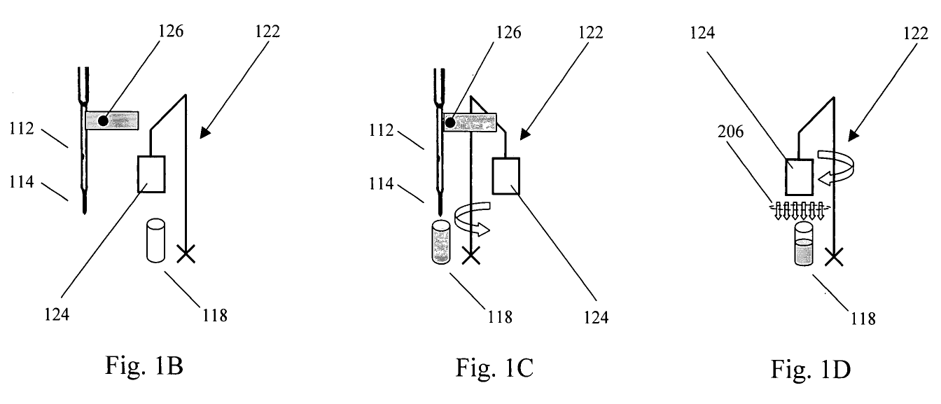

In brief overview, FIG. 1A is a perspective view of a robotic system 100 in accordance with an embodiment of the invention. In the depicted embodiment, the system 100 is configured to handle fluidic volumes, including chemical and biological materials. The system 100 typically includes two or more movable devices 102A, 102B (collectively, 102), that are capable of moving in at least two and preferably three directions (i.e., along the x-, y-, and z-axes). Controller 104A is in communication with the movable device 102A, and controller 104B is in communication with the movable device 102B, to control the movement of each movable device. In an alternative embodiment, a single controller is in communication with all movable devices 102 to control their movements (separately or conjunctively). In either case, an operator uses a computer 105, typically a personal computer, to programmatically control or set each of the controllers 104A, 104B (collectively, 104), or movable devices 102, or both.

Each of the movable devices 102 moves independently of the other movable devices 102. In other words, one movable device 102A can be directed by the controller 104A to move in a different direction, or at a different rate, or both, compared to a second movable device 102B. A user typically accomplishes this by programming the controllers 104 with the corresponding commands or software using the computer 105.

The system 100 typically includes a rail 106 along which the movable devices 102 move. As shown in FIG. 1A, movement along the rail 106 corresponds to movement along a y-axis. The system 100 also includes a deck 108 on which samples, reagents 110, or other objects are placed. In general, each of the movable devices 102 is capable of manipulating items placed on the deck 108.

In some embodiments, the movable devices 102 include mating adapters 112A, 112B (collectively, 112) that link each of the movable devices 102A, 102B to functional tips 114A, 114B, respectively. The tips 114A, 114B (collectively, 114) perform particular functions. For example, the tips 114 can include gripping paddles that grasp the samples 110 or other objects placed on the deck 108. In this configuration, the movable devices 102 are able to manipulate the items on the deck 108. The tips 114 can also include pipettes that dispense and collect sample volumes for analysis.

A storage region 116 can be located within the range of movement of the movable devices 102. The storage region 116 is a repository for, for example, the tips 114. When one of the movable devices 102 needs a particular tip to perform a particular function, the controller 104 for that particular movable device 102 (i) directs the movable device 102 to travel to the storage region 116, (ii) locates the needed tip 114, and (iii) causes the movable device 102 to connect to the needed tip 114 using the mating adapter 112. After performing the particular function, the controller 104 can direct the movable device 102 to return to the storage region 116, disconnect the tip 114, and leave the tip 114 in the storage region 116. This facilitates use of the particular tip 114 by another of the movable devices 102.

In some embodiments, the tips 114 include sensors that monitor the environment in or around the system 100. For example, the tips 114 can include an ultrasonic transmitter and an ultrasonic receiver. In one embodiment, the transmitter and receiver are combined into a single module. In another embodiment, the single module is contained in an ultrasonic transducer. In either case, one or more of the ultrasonic transmitter, ultrasonic receiver, or module is movable, typically when in contact with at least one of the movable devices 102. For example, one of the movable devices 102 could pick up, or move, or push the ultrasonic device.

Embodiments using ultrasonic components typically use the components to assess distances and surface conditions. This is accomplished by taking advantage of the piezoelectric effect that ultrasonic transmitters and ultrasonic receivers exhibit. Materials demonstrating the piezoelectric effect (i.e., the generation of electricity in crystals subjected to mechanical stress, and the generation of stress in such crystals when they are subjected to an applied voltage) can be employed as both an ultrasonic transmitter and an ultrasonic receiver (i.e., a single piezoelectric object can serve as transmitter and receiver). Separate transmitter and receiver devices are also contemplated.

A typical sequence of events comprises the ultrasonic transmitter emitting an ultrasonic signal that encounters an object or obstruction. This generates a return ultrasonic “echo” signal. The ultrasonic receiver senses this echo and converts it to an electrical signal that is subjected to further signal processing. Either the controller 104 or another processor (such as the computer 105) can perform this signal processing, typically in conjunction with additional signal conditioning hardware. Software (running on the computer 105, for example) then analyzes the processed signal to characterize the sensed object or obstruction. This can include an assessment of distance between the ultrasonic devices and the object or obstruction. The system 100 can then choose among several options for proceeding with its tasks, depending on the presence and nature of the sensed object or obstruction.

In some embodiments, the ultrasonic components can be used to sense the absence of an obstruction. For example, samples 110 would give rise to an echo signal when subjected to a transmitted ultrasonic signal. If the samples 110 were moved, the expected echo signal would not be received, and the system 100 could proceed accordingly (e.g., abort the operation, signal an alarm 120, check another location for the samples 100, etc.).

Because the ultrasonic components can sense surfaces, some embodiments employ them to detect the level of liquid in a container. The ultrasonic components sense the “surface” of the liquid itself by emitting an ultrasonic signal that impinges the surface of the liquid. The ultrasonic receiver senses the echo signal reflected back from the surface of the liquid, and the controller 104 or another processor (such as the computer 105) processes this signal. By assessing the characteristics of the echo signal (e.g., the elapsed time between its reception and the earlier ultrasonic transmission), the system 100 gauges the volume of liquid in the samples 110.

In some embodiments, the tips 114 include other types of sensors, generally referred to as “perception sensors” because the sensors collect information about their immediate environment. For example, in one embodiment, the tips 114 include a position sensor that allows the movable device 102 to ascertain its location within the system 100. Of course, other types of position sensors may be used as well. For example, an optical encoder in communication with the movable device 102 can also provide position information. In other embodiments, the perception sensors include a radar transmitter and receiver (i.e., a radar system), or a laser transmitter and receiver (e.g., a LIDAR system, which involves detecting distant objects and determining their position, velocity, or other characteristics by analysis of laser light reflected from their surfaces).

As described above, changing the tips 114 allows the movable devices 102 to perform different functions, depending on the task as hand. Nevertheless, in some embodiments, one or more movable devices 102 may have fixed functionalities, typically achieved by permanently connecting the movable device 102 to a particular tip 114. In this configuration, the permanently connected tip 114 may have a design that is different from the removable tips 114 described above and, instead, could be an integral part of the corresponding movable device 102.

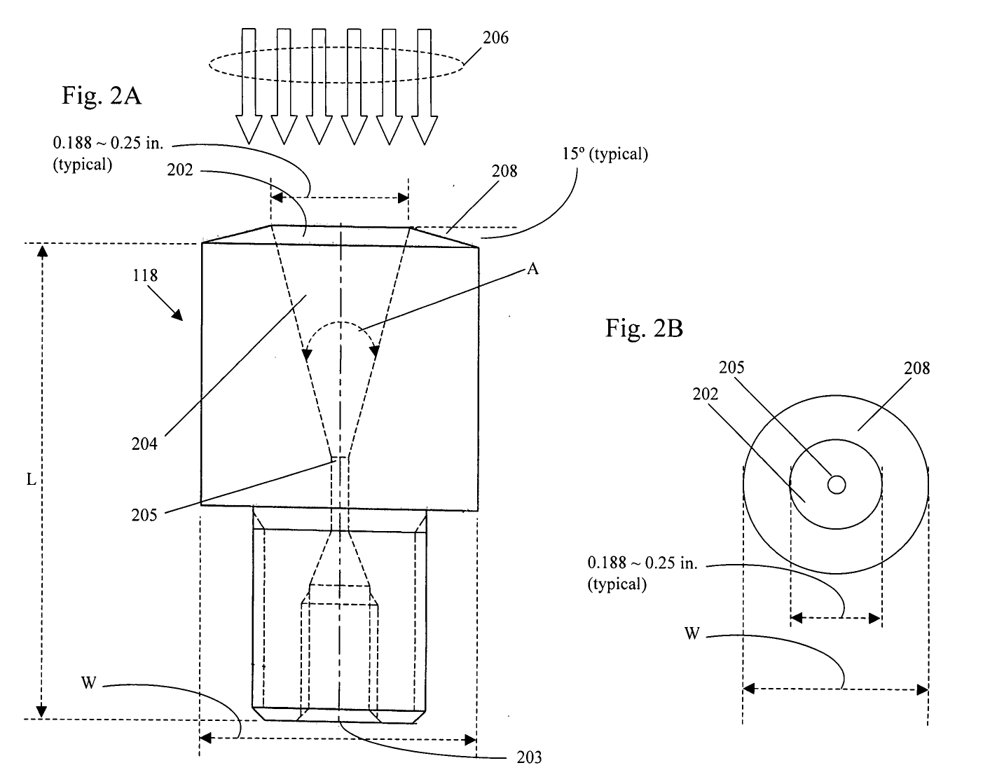

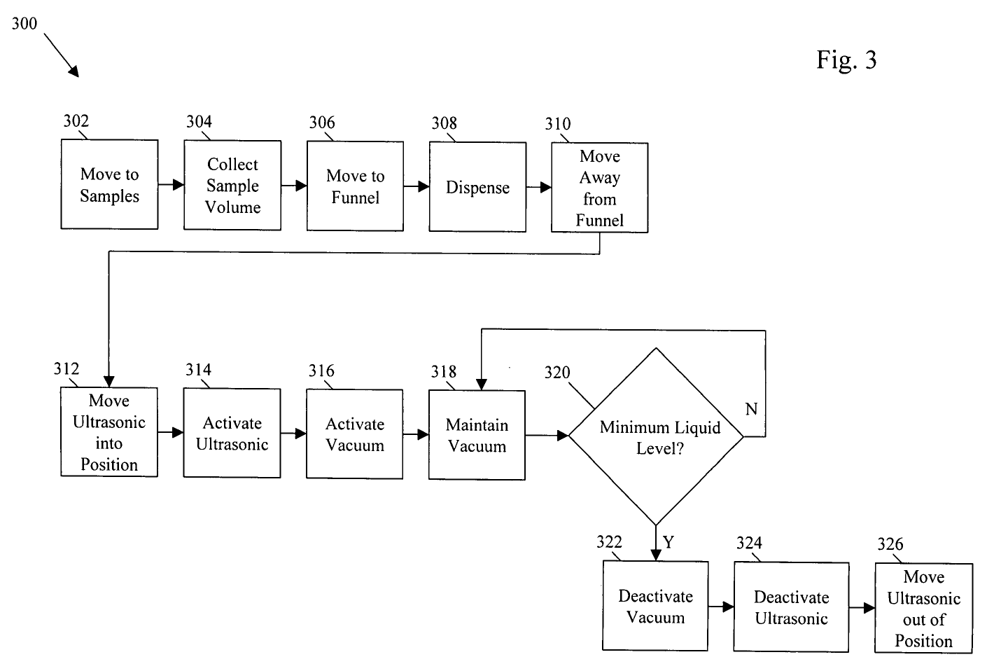

In some embodiments, the system 100 includes or interacts with a funnel 118, depicted generally in FIG. 1A and more specifically in FIGS. 2A and 2B. (FIG. 2B is a top view of the funnel 118.) The funnel 118 can be constructed from any suitable material, including a keytone-based polymer such as polyetheretherketone which can be obtained from PLC Corporation under the trademark PEEK®. Sample volumes (e.g., reagents) are dispensed into the funnel 118 through an aperture 202. In various embodiments, the aperture 202 has a diameter of approximately 0.188 inch to approximately 0.25 inch. The funnel may be located on the deck 108 or anywhere accessible by the movable devices 102. The funnel 118 is typically connected to additional analysis hardware using piping or tubing for transporting the sample volumes that are introduced into the aperture 202. The tubing can be connected to a bottom port 203 of the funnel 118. In one embodiment, the funnel 118 has a length (L) of approximately 0.88 inch and a diameter or width (W) of approximately 0.50 inch. In another embodiment, the funnel 118 has a length (L) of approximately 1.03 inches and a diameter or width (W) of approximately 0.50 inch.

As shown in FIG. 2A, the funnel 118 typically has an interior chamber 204 that receives the sample volumes. The interior chamber 204 defines an inner aperture 205 through which the sample volumes pass when traveling to the bottom port 203. In some embodiments, at least a part of the interior chamber 204 has a conical cross section characterized by an opening angle A. In some embodiments, the opening angle is approximately thirty degrees. In other embodiments, the opening angle is approximately 10 to approximately 25 degrees, preferably about 20 to approximately 21.5 degrees. In any case, this configuration facilitates the visual and ultrasonic inspection of liquid level in the funnel 118. For example, as the level of liquid is reduced in the interior chamber 204, the taper of the walls of the chamber 204 (due to the conical cross section) causes the diameter of the top surface of the liquid to become smaller. This reduction in the diameter is observable to the naked eye. In contrast, if the walls of the chamber 204 were not tapered (e.g., if the chamber 204 did not have a conical cross section), it would be more difficult to observe changes in the level of the liquid from a viewpoint above the funnel 118, in part because the diameter of the top surface of the liquid would not change according to the liquid level.

In embodiments in which the funnel 118 and an ultrasonic transducer are used together, the system 100 provides a method 300 for monitoring of liquid levels, as depicted in FIG. 3. This arrangement typically includes having a controller 104 command at least one of the movable devices 102 configured as a pipette to (i) move to the samples 110 (STEP 302), (ii) collect a sample volume (STEP 304), (iii) move to the funnel 118 (STEP 306), (iv) dispense the contents of the pipette into the funnel 118 (STEP 308), and (v) move away from the funnel 118 (STEP 310). In some embodiments, the controller 104 would then instruct the movable device 102 to disconnect from the pipette and connect to the ultrasonic transducer. In other embodiments, a different movable device 102 would connect to the ultrasonic transducer. In yet other embodiments, the ultrasonic transducer is an integral part of another movable device 102. In any case, the controller 104 commands the movable device 102 having the ultrasonic transducer to move to a position over the funnel 118 (STEP 312). The controller 104 then activates the ultrasonic transducer (STEP 314), which emits an ultrasonic signal 206 shown in FIG. 2A. In an alternative embodiment, the ultrasonic transducer is active at all times and thus constantly or periodically emitting the signal 206 without the need for the controller 104 to activate specifically the transducer at a particular point in time as indicated by STEP 314. Whether the transducer is active at all times or just activated at a certain time, the resulting ultrasonic echo signal is received by the active transducer, and this return signal then can be processed by the controller 104, computer 105, or some other computer or processing equipment to allow the level of liquid in the funnel 118 to be determined.

In an alternative embodiment, a transducer transport 122 is disposed adjacent to the funnel 118. As shown in FIG. 1B, the transducer transport 122 includes an ultrasonic transducer 124, and is spring loaded or otherwise biased such that it remains adjacent to the funnel 118. The movable device 102 configured as a pipette includes a bumper 126 that may be attached to the mating adapter 112 as shown in FIG. 1B, or anywhere else on the movable device 102 or tip 114, such that the bumper 126 contacts the transducer transport 122 as the movable device 102 approaches the transducer transport 122. In this configuration, the bumper 126 pushes the transducer transport 122 so the latter moves away from the movable device 102 and the funnel 118 thereby giving the pipette unobstructed access to the funnel 118. The pipette then dispenses its contents into the funnel 118. Once this is completed, the movable device 102 moves away from the funnel 118 and the transducer transport 122 returns to a position adjacent to the funnel 118, as shown in FIG. 1D. Movement of the transducer transport 122 may be rotational, as shown in FIGS. 1C and 1D, or translational (not depicted). At this point, the ultrasonic transducer 124 can be activated to emit the ultrasonic signal 206 or, in an alternative embodiment, the ultrasonic transducer 124 is active at all times and thus constantly or periodically emitting the signal 206 without the need to be activated specifically at a particular point in time.

In a different embodiment (not depicted), the transducer transport 122 and the ultrasonic transducer 124 may be fixed (i.e., not movable) above the funnel 118, but oriented such that the movable device 102 may have unobstructed access to the funnel 118. This may be achieved, for example, by mounting the transducer transport 122 above the space where the movable device 102 travels but sufficiently close to the funnel 118 to perform an ultrasonic measurement of the liquid level therein. The ultrasonic transducer 124 can emit the ultrasonic signal 206 after the pipette dispenses its contents into the funnel 118 or, in an alternative embodiment, the ultrasonic transducer 124 is active at all times and thus constantly or periodically emitting the signal 206 without the need to be activated specifically at a particular point in time.

After the liquid is dispensed into the funnel 118, the liquid is drawn down and transported to additional analysis hardware. In one embodiment (not depicted), the controller 104 activates a valve that permits the liquid in the funnel 118 to be drawn down by gravity. In another embodiment, the controller 104 activates a vacuum (STEP 316) that draws down the liquid (STEP 318). As the liquid is drawn down, the ultrasonic transducer senses the increasing distance between the components and the surface of the liquid (STEP 320). The controller 104, computer 105, or some other computer or processing equipment interprets this and, before the liquid level falls below a prescribed (e.g., minimum acceptable) level, deactivates the vacuum (STEP 322) (or closes the valve), deactivates the ultrasonic transducer (STEP 324), and may also move the ultrasonic transducer to a position away from the funnel 118 (STEP 326). In an alternative embodiment in which the ultrasonic transducer is active at all times and thus constantly or periodically emitting an ultrasonic excitation signal and also receiving any return ultrasonic echo signals without the need to be activated specifically at a particular point in time, the deactivation STEP 324 is unnecessary. In any event, by combining the detection of the liquid level with the control of the valve or vacuum, the system 100 is able to adjust the liquid level as needed.

When the ultrasonic signal 206 impinges on the funnel 118, the echo signal typically includes reflections from other nearby objects. These spurious reflections are unrelated to the liquid level and compromise the accuracy of the liquid level determination. One source of the spurious reflections is the upper edge 208 of the funnel 118. Edges that are perpendicular to the impinging ultrasonic signal 206 typically give rise to strong reflections (e.g., reflections that travel back to the ultrasonic components along the initial axis of propagation). In some embodiments, the edge 208 is designed to deflect the ultrasonic signal 206 so a reflection from the edge 208 will be minimized or, ideally, not travel back to the ultrasonic components. This can be accomplished by beveling the edge 208, typically at an angle of at least fifteen degrees. Beveling at other angles is possible and also can result in reducing or eliminating reflections due to the upper edge 208 of the funnel 118. For example, a beveling of greater than fifteen degrees (e.g., thirty or forty degrees) may reduce unwanted reflection more than a beveling of about fifteen degrees.

Note that in FIGS. 1A through 3 the enumerated items are shown as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signals embodied in one or more of a carrier wave, a computer disk (magnetic, or optical (e.g., CD or DVD), or both), non-volatile memory, tape, a system memory, and a computer hard drive.

From the foregoing, it will be appreciated that systems and methods according to the invention afford a simple and effective way to monitor surfaces, including liquid levels.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A system comprising:
a plurality of movable devices, at least one of which comprises an ultrasonic transmitting and receiving module that includes a liquid level sensor; and
a controller in communication with each of the devices for independently controlling the movement of each device.

2. The system of claim 1, wherein the controller is one of a plurality of controllers, each of the controllers in communication with a different one of the devices.

3. The system of claim 1, wherein the ultrasonic transmitting and receiving module comprises an ultrasonic transducer.

4. The system of claim 1, wherein the ultrasonic transmitting and receiving module comprises separate ultrasonic transmitter and receiver components.

5. The system of claim 1, further comprising a position sensor.

6. The system of claim 3, wherein the ultrasonic transducer is removable from the movable device.

7. The system of claim 1, wherein at least one other of the plurality of controllably movable devices is adapted to manipulate an object.

8. The system of claim 1, wherein at least one other of the plurality of controllably movable devices comprises a pipette.

9. The system of claim 8, further comprising a funnel for receiving reagents from the pipette.

10. The system of claim 9, wherein the funnel comprises at least one surface designed to deflect ultrasonic radiation.

11. The system of claim 10, wherein the at least one surface comprises a beveled edge.

12. The system of claim 11, wherein the beveled edge has an angle of at least about 15 degrees.

13. The system of claim 9, wherein the funnel defines an interior chamber having a cross section that is conical at least in part.

14. The system of claim 1, further comprising an alarm in communication with the ultrasonic transmitting and receiving module.

15. The system of claim 1, wherein the ultrasonic transmitting and receiving module comprises a piezoelectric device.

16. The system of claim 15, wherein the piezoelectric device is both a transmitter and a receiver.

17. The system of claim 1, wherein the ultrasonic transmitting and receiving module is movable by contact with another member of the plurality of movable devices.

18. A method for detection of a liquid level, the method comprising the steps of:
moving at least one pipette, using a first controllably movable device, to a position over a funnel;
dispensing contents of the pipette into the funnel;
moving an ultrasonic transmitter and receiver over the funnel;
activating the ultrasonic transmitter; and
detecting a liquid level in the funnel with the ultrasonic receiver.

19. A system comprising:
a plurality of movable devices, at least one of which comprises a perception sensor capable of detecting a liquid level; and
a controller in communication with each of the devices for independently controlling the movement of each device.

20. The system of claim 19, wherein the perception sensor comprises at least one of an ultrasonic transmitter, an ultrasonic receiver, a vision system, a radar system, or a LIDAR system.
